(19) United States
(12) Patent Application Publication
(10) Pub. No.: US 2014/0211009 A1
(43) Pub. Date: Jul. 31, 2014

(54) LENS ASSEMBLY FOR VEHICLE VISION SYSTEM CAMERA

(71) Applicant: Magna Electronics Inc., Auburn Hills, MI (US)

(72) Inventor: Manfred Fürsich, Oberhaching (DE)

(73) Assignee: Magna Electronics Inc., Auburn Hills, MI (US)

(21) Appl. No.: 14/163,325

(22) Filed: Jan. 24, 2014

Related U.S. Application Data
(60) Provisional application No. 61/814,533, filed on Apr. 22, 2013.
(60) Provisional application No. 61/807,050, filed on Apr. 1, 2013.
(60) Provisional application No. 61/756,832, filed on Jan. 25, 2013.

(51) Int. Cl. H04N 7/18; G02B 13/04; H04N 5/232

(52) U.S. Cl. CPC H04N 7/18; H04N 5/23238; G02B 13/04
USPC 348/148

(57) ABSTRACT

A vehicular vision system includes a camera having an image sensing array and a lens assembly. The camera is disposed at a vehicle and has a field of view exterior of the vehicle, and the image sensing array is operable to capture image data. The lens assembly images light onto the image sensing array and the lens assembly includes a plurality of optic elements disposed along an optic path generally perpendicular to the image sensing array. The plurality of optic elements includes (i) an outer wide angle glass optic, (ii) a doublet optic comprising two optic elements that are bonded together and (iii) at least one intermediate plastic optic disposed between the doublet optic and the outer wide angle glass optic, with the doublet optic disposed closer to the image sensing array than the outer wide angle glass optic.

### CROSS REFERENCE TO RELATED APPLICATIONS

The present application is related to U.S. provisional applications, Ser. No. 61/814,533, filed Apr. 22, 2013; Ser. No. 61/807,050, filed Apr. 1, 2013, and Ser. No. 61/756,832, filed Jan. 25, 2013, which are hereby incorporated herein by reference in their entireties.

### FIELD OF THE INVENTION

The present invention relates to vehicles with cameras mounted thereon and in particular to vehicles with one or more exterior-facing cameras, such as rearward facing cameras and/or the like.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties. The imaging sensors or cameras utilize lenses or lens optics or lens assemblies, such as those described in U.S. Pat. Nos. 6,590,719 and/or 7,929,221 and/or Chinese Publication Nos. CN000101614864A and/or CN000202256848U and/or European Pat. No. EP 2 187 250, which are hereby incorporated herein by reference in their entireties.

### SUMMARY OF THE INVENTION

The present invention provides a camera for a vision system that utilizes one or more cameras or image sensors to capture image data of a scene exterior (such as forwardly) of a vehicle and provides a display of images indicative of or representative of the captured image data. The camera has a lens assembly for imaging light at the image sensing portion or array of the camera. The lens images light onto the imaging array of the camera and the lens assembly comprises a plurality of optic elements disposed along an optic path at the imaging array or image sensing array. The plurality of optic elements comprises (i) an outer wide angle glass optic, (ii) at least one intermediate plastic optic and (iii) a doublet optic comprising two optic elements that are bonded together.

Optionally, the doublet optic may comprise two plastic optic elements that are bonded together. Optionally, the at least one intermediate plastic optic of the plurality of optic elements comprises a second plastic optic disposed behind the outer wide angle glass optic and a third plastic optic disposed between the second plastic optic and the doublet optic. Optionally, the at least one intermediate plastic optic of the plurality of optic elements comprises a fourth optic disposed between the third plastic optic and the doublet optic. Optionally, the fourth optic is bonded to one of the optics of the doublet.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a schematic of a lens assembly in accordance with the present invention;

FIG. 3 is another schematic of the lens assembly of FIG. 2, showing light refracting as it passes through the lens optics;

FIG. 4 is a schematic of a doublet of the lens assembly of the present invention;

FIG. 5 shows a lens assembly wherein the positions 4 and 5 comprising a duplet of two lenses, such as at positions 4 and 5 comprising glass elements and at position 6 comprising a plastic element;

FIG. 6 shows a lens assembly with the positions 4, 5 and 6 comprising plastic elements with an air gap between the elements and no duplet or triplet;

FIG. 7 shows a lens assembly of the present invention, with the positions 5 and 6 comprising a duplet of two lenses, with all three lens elements comprising plastic elements in accordance with the present invention;

FIG. 8 shows an exemplary mechanical design of a full lens system according to the present invention;

FIG. 8A is a sectional view of the lens system of FIG. 8 when assembled; and

FIG. 9 shows the mounting configuration with barrel, lens holder and imager in accordance with the present invention.

### DETAILED DESCRIPTION OF THE INVENTION

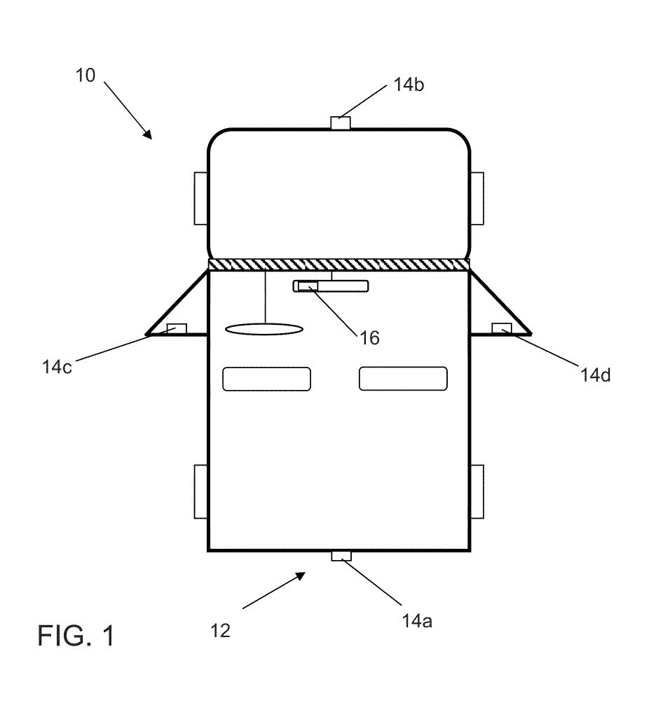

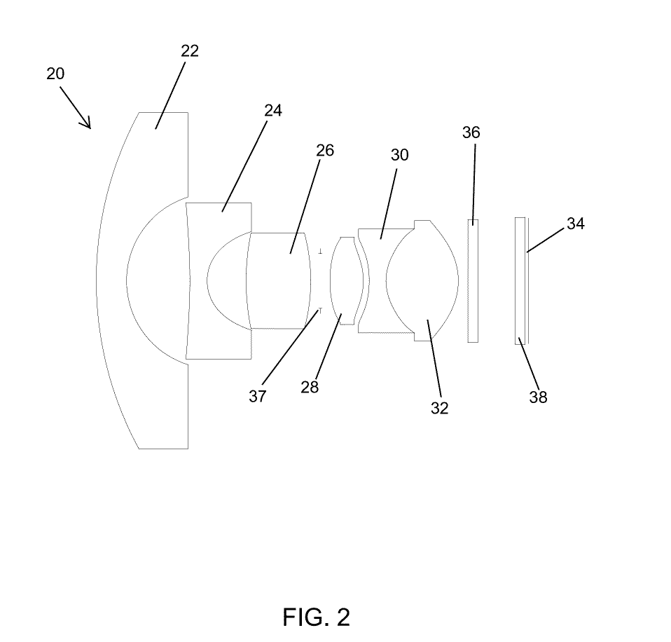

Referring now to the drawings and the illustrative embodiments depicted therein, a vehicle 10 includes an imaging system or vision system 12 that includes one or more imaging sensors or cameras (such as a rearward facing imaging sensor or camera 14a and/or a forwardly facing camera 14b at the front (or at the windshield) of the vehicle, and/or a sidewardly/rearwardly facing camera 14c, 14d at the sides of the vehicle), which capture images exterior of the vehicle, with the cameras having a lens for focusing images at or onto an imaging array or imaging plane of the camera (FIG. 1). The vision system 12 is operable to process image data captured by the cameras and may provide displayed images at a display device 16 for viewing by the driver of the vehicle. Optionally, the vision system may process image data to detect objects, such as objects to the rear of the subject or equipped vehicle during a reversing maneuver, or such as approaching or following vehicles or vehicles at a side lane adjacent to the subject or equipped vehicle or the like.

The present invention provides an ultra-wide angle lens which may be used in a surround view camera system in a vehicle. The lens provides the following characteristics:
High field angles (such as, for example, a horizontal field-of-view of about 190 degrees and/or a diagonal field-of-view of about 200 degrees).
Moderate distortion.
Good sharpness (high MTF values).
Image circle matching to imager (such as an Aptina AR0132 or the like).
Good color correction.
Sharp image at high and low temperatures.
Suitable for use with cameras mounted at the outside of a vehicle.
Lens and camera stable and dense to outdoor conditions.
Low stray light because imager may comprise a high dynamic imager.
Flat incident angles to the sensor considering the principle ray angle behavior of the imager.
low f/# as low as 2.0 yields a good low light performance.
compact design.

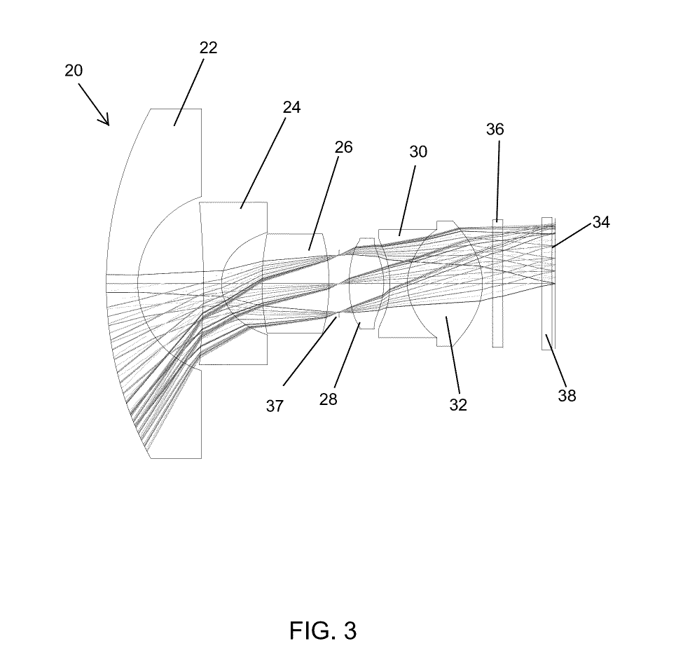

As shown in FIGS. 2 and 3, the lens assembly 20 of the present invention comprises a plurality of optics, which include a first or outer or wide angle optic 22 and a second optic 24 disposed behind said first optic 22. A third optic 26 is disposed at and behind the second optic 24 and an aperture 37 is disposed behind the third optic 26. A fourth optic 28 is disposed behind the aperture 37. A fifth optic 30 and a sixth optic 32 may be joined or bonded together (and may comprise a doublet optic), such as via an optical adhesive or cement or the like, and are disposed between the fourth optic 28 and the imaging array or sensor 34. The lens assembly may optionally also contain an Infra-Red Light blocking filter 36 and a sensor cover glass 38.

The first lens element or optic 22 preferably comprises a glass spherical optic having a high refraction index n and a high or higher Abbe coefficient, with a convex object surface (the outer surface towards the imaged scene) and a concave image surface (the inner surface towards the imaging array). Optionally, the first optic may comprise an aspheric molded glass lens element or the like. Glass is a preferred material because of the higher stability with respect to scratches, since this is the outermost optic and may be exposed. A spherical curvature or shape or form is preferred since this is lower cost with glass elements.

The second lens element or optic 24 preferably comprises a plastic aspheric optic having a high or higher Abbe coefficient.

The third lens element or optic 26 preferably comprises a glass spherical optic having a high refraction index ‘n’ and a low or lower Abbe coefficient, with a convex object surface and a convex image surface. Optionally, the third optic may comprise an aspheric plastic lens element or the like. Glass is a preferred material because of the better thermal properties that glass provides. However, use of a plastic lens element may reduce cost. Behind the third optic 26 there is the aperture 37, which defines the f/# of the lens. This aperture may be formed through any suitable material, such as, for example, brass or the like.

The fourth optic 28, fifth optic 30 and sixth optic 32 preferably all three comprise plastic, with an air gap between the fourth and fifth optics 28, 30, and with the fifth and sixth optics 30, 32 bonded or adhered together, such as via an optical adhesive or cement or the like, to form a doublet lens element. The fourth and sixth lens elements or optics 28, 32 preferably have a high or higher Abbe coefficient, and the fifth lens element or optic 30 has a low or lower Abbe coefficient. Optionally, the lens assembly may not include the fourth lens element or optic to potentially reduce costs. Optionally, the lens assembly may have the fourth, fifth and sixth optics adhered together to form a triplet lens element, which may be advantageous with respect to stray light and tolerances. To put the single lens element 28 in front of the doublet 30, 32 has the advantages of smoother refractions which may yield better tolerance behavior and reduced Fresnel reflections.

Optionally, the lens elements may have selected refraction indices and Abbe coefficients. For example, the first lens element may have a refraction index that is greater than or equal to about 1.65 and an Abbe coefficient that is greater than or equal to about 50, while the second lens element may have a refraction index that is greater than or equal to about 1.45 and an Abbe coefficient that is greater than or equal to about 50, and the third lens element may have a refraction index that is greater than or equal to about 1.65 and an Abbe coefficient that is less than or equal to about 30, and the fourth lens element may have a refraction index that is greater than or equal to about 1.5 and an Abbe coefficient that is greater than or equal to about 50, and the fifth lens element may have a refraction index that is greater than or equal to about 1.5 and an Abbe coefficient that is less than or equal to about 30, and the sixth lens element may have a refraction index that is greater than or equal to about 1.5 and an Abbe coefficient that is greater than or equal to about 50.

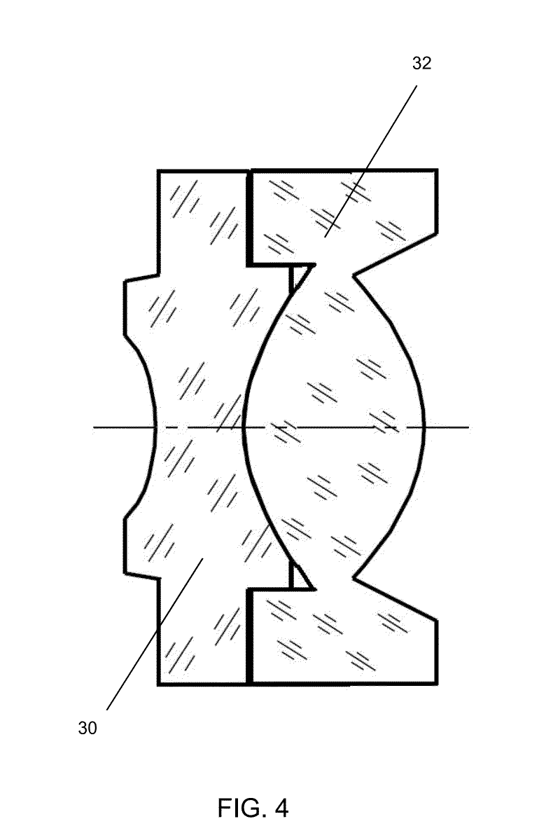

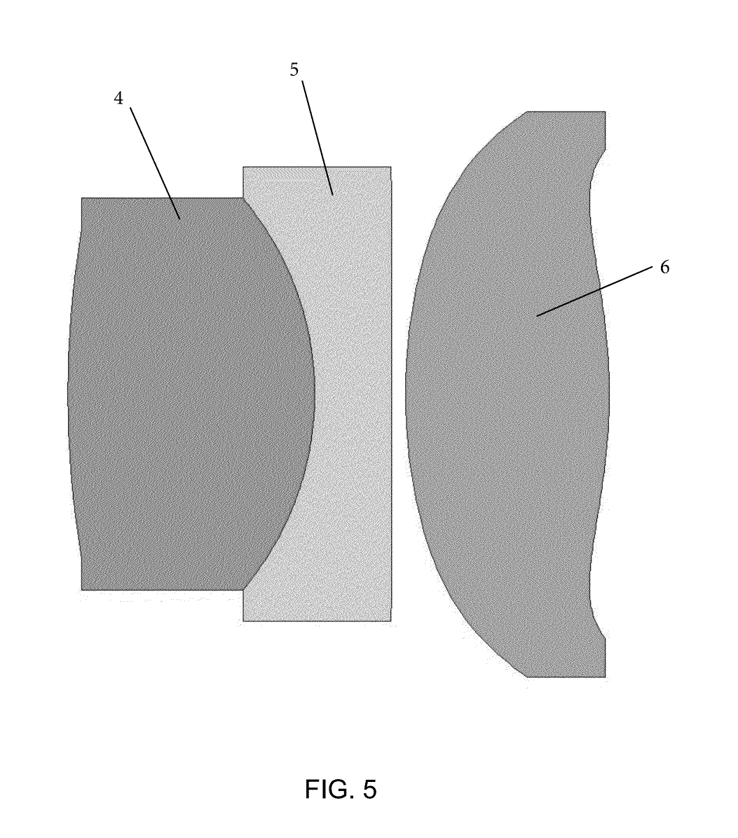

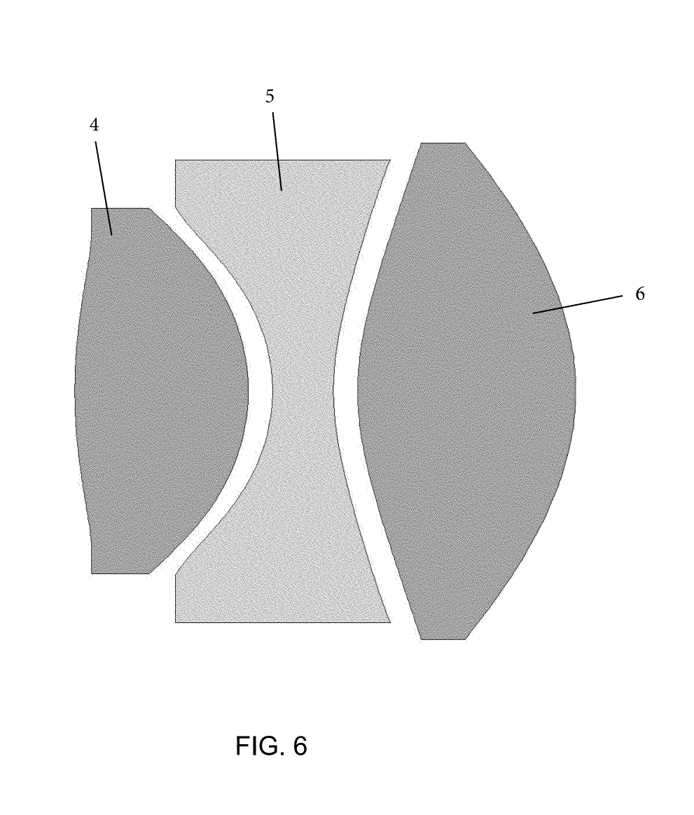

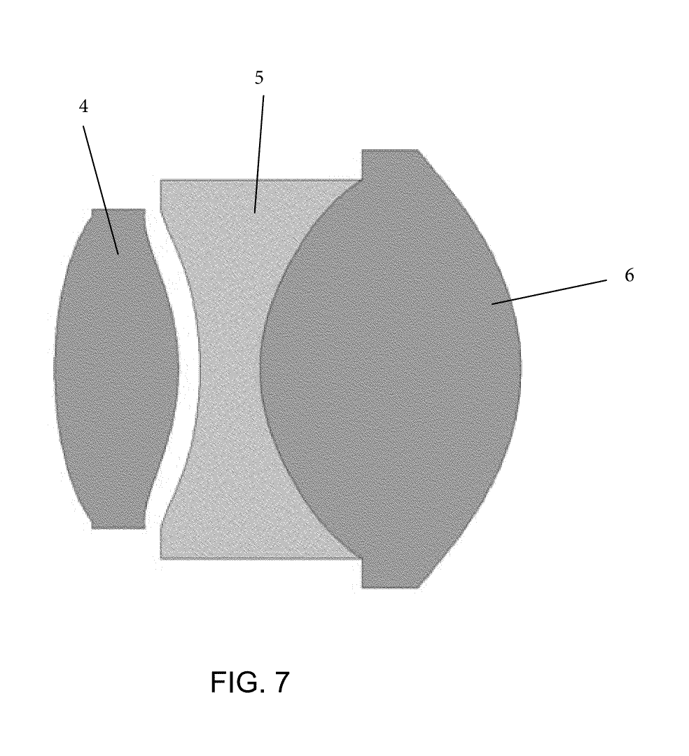

The gluing of the doublet optics may be achieved via any suitable adhesive and manner. Optionally, and desirably, the optics are plasma treated and bonded or adhered or cemented via an epoxy resin or the like, such as a Delo AD610 adhesive or the like (such as described in U.S. patent application Ser. No. 13/260,400, filed Sep. 26, 2011 (Attorney Docket MAG04 P-1757), and/or International Publication No. WO 2013/063014, which are hereby incorporated herein by reference in their entireties). The adhesive may comprise an optical adhesive such that the cured adhesive layer may be substantially optically matched with the optical index of the bonded optic elements. Optionally, an acrylate glue or modified acrylate glue may be used. Optionally, and as shown in FIG. 4, the space of redundant glue should be considered.

Optionally, the camera may include an infrared filter 36 disposed between the lens assembly and the imaging array 34. Preferably, the filter 36 comprises a combination of an absorbing glass (such as Schott BG40 or the like) together with a high quality infrared (IR) coating. The object side of the filter may have an IR coating and the image side of the filter may have an AR coating. Optionally, the filter may comprise a normal or non-absorbing glass with an AR coating on the object side of the filter and an IR coating the image side of the filter. Optionally, and desirably, a high quality design of the IR filter may be provided for enhanced low stray light behavior. Optionally, the imaging array 34 may be protected by a cover glass 38.

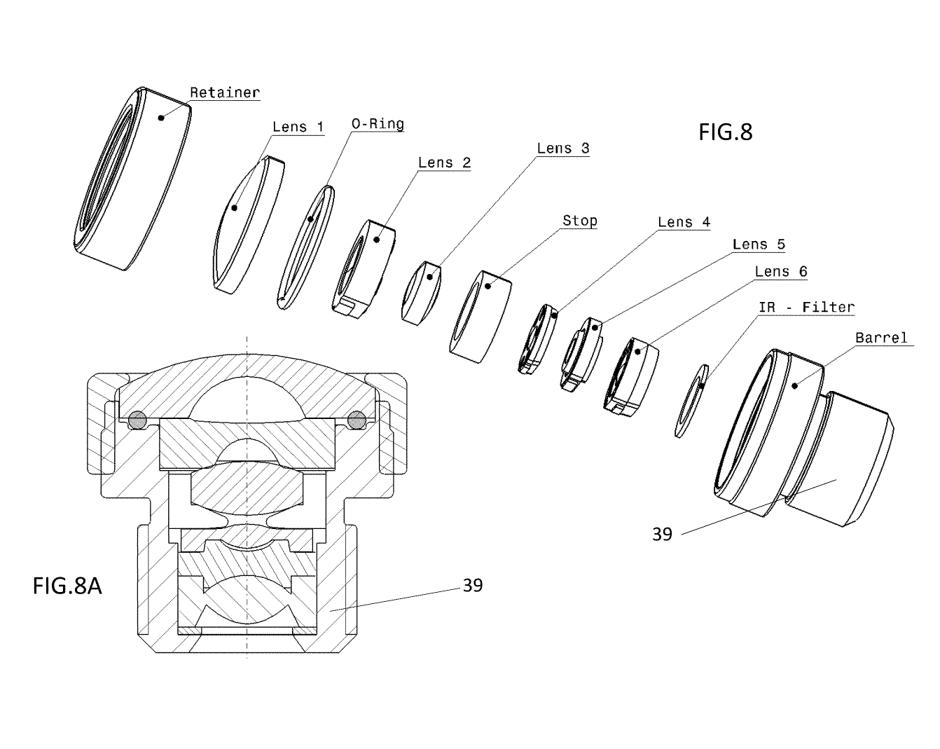

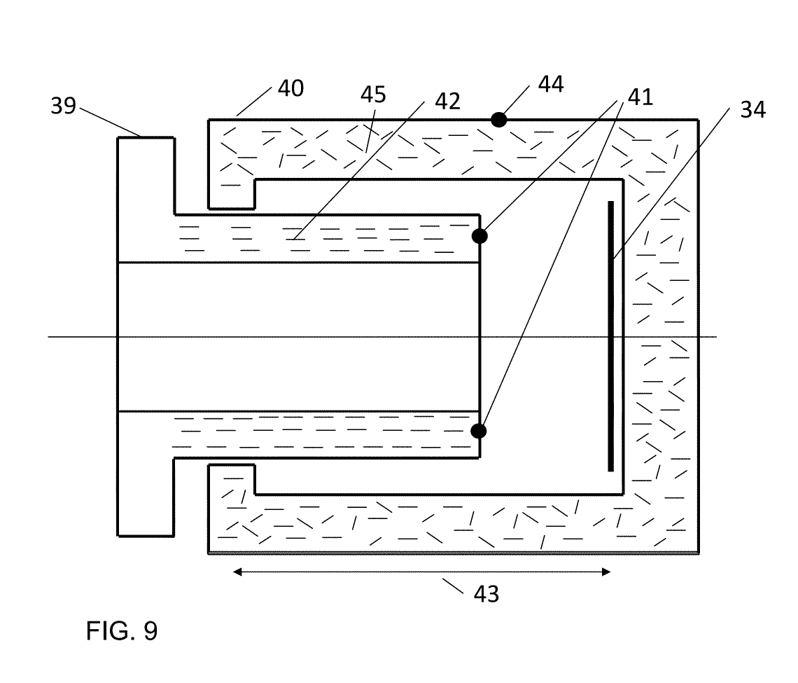

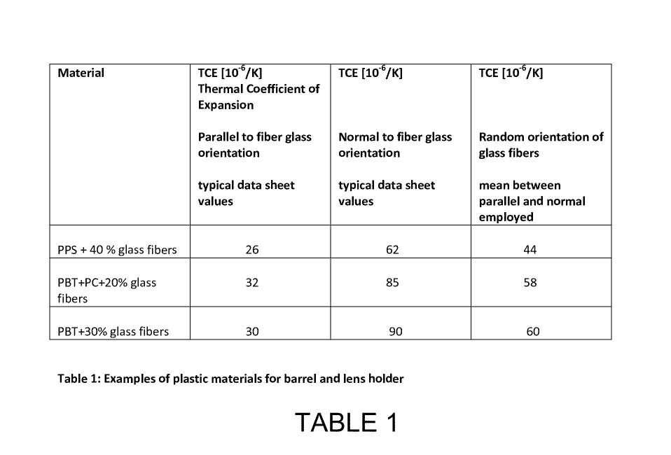

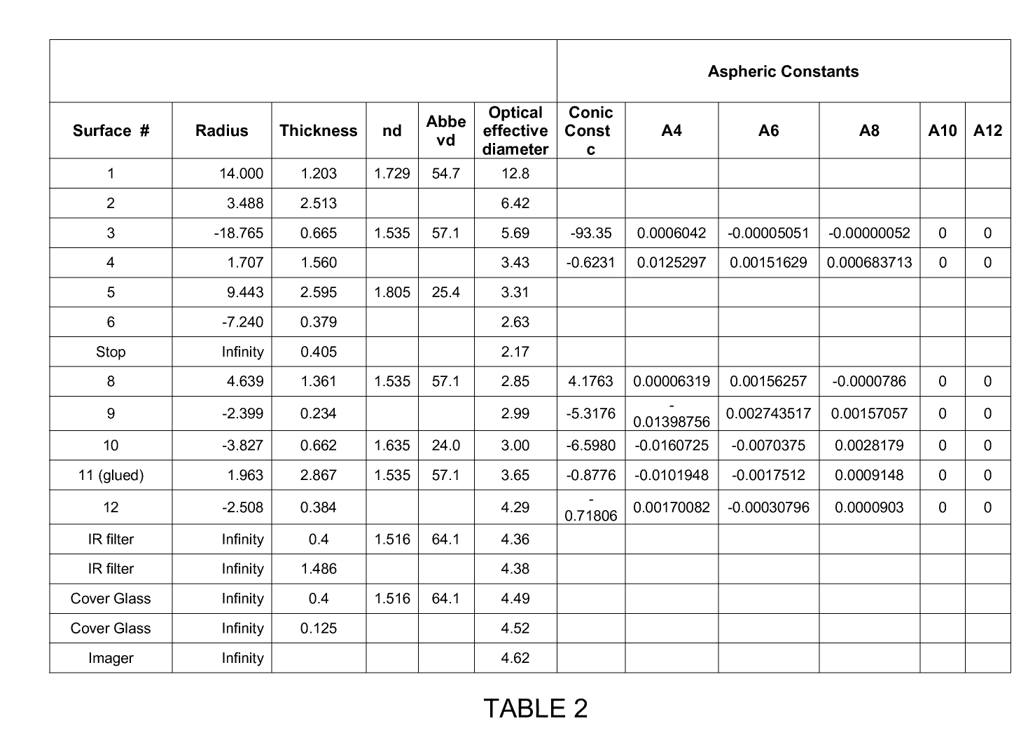

The lens assembly is housed in a barrel 39 (as shown in FIGS. 8, 8A and 9) and a lens holder 40 (FIG. 9) that holds the optics relative to the imaging array so that the lens assembly properly images light onto the imaging array. The barrel 39 and lens holder 40 may comprise any suitable materials. In the illustrated embodiment of FIGS. 8 and 8A, the lens assembly includes six lens elements or optics (with the first lens element comprising an outer lens element having its outer surface facing the exterior of the vehicle and the sixth lens element comprising an inner lens element closest to the imaging array sensor), with an infrared filter at one end and a stop (having an aperture therethrough) disposed between the third lens element and the fourth lens element.

By using many plastic lens elements in the optical design, the focus points shift (and may shift substantially) behind the imager when the temperature increases. In order to compensate this effect and to maintain a good or acceptable thermal behavior having sharp image quality at high and low temperatures, it is important to adjust the thermal coefficient of expansion (TCE) of the barrel 39 and the lens holder 40 by choosing adequate or appropriate materials. Additionally, it is of importance to adjust the matching distance 43 and the glass fiber orientation of the barrel 42 and the glass fiber orientation of the lens holder 45 properly. Example thermal coefficient of expansion (TCE) data for different materials is shown in Table 1. Column 2 of Table 1 shows data for plastic materials with the glass fiber orientation parallel to the optical axis. Column 3 of Table 1 shows the TCE values for plastic materials with the glass fiber orientation normal to the optical axis. In column 4 of Table 1, the case of random glass fiber orientation is shown. It seems clear to take the mean of the TCE for the generally parallel and generally normal glass fiber orientations. In order to compensate the focus shift behind the imager, one needs a barrel 39 with low TCE value and a lens holder 40 with high TCE value. The compensation effect also increases with a higher matching distance 43. The barrel 39 may, for example be made of PPS with about 40 percent of glass fibers.

To achieve a low TCE value of the barrel 39, it is necessary that the glass fibers 42 are oriented parallel or generally parallel to the optical axis. This can be reached by arranging the injection point 41 at the rear side of the barrel 39. In order to further improve the parallelism, several injection points 41 may be used. A further possibility to achieve a glass fiber orientation parallel or generally parallel to the optical axis is via usage of a round film gate at the rear side of the barrel. The lens holder 40 may, for example, be made of PPS or PBT or PBT+PC, all three with additional glass fibers. In order to obtain a high TCE value, the glass fibers should be ideally arranged normal or generally normal to the optical axis. This is difficult to achieve. As can be seen in Table 1, column 4, a random orientation of the glass fibers 45 yields a desired higher TCE value. Random fiber orientation may be achieved by providing only one injection point 44 at the side of the lens holder 40.

Referring to Table 2, the parameters of an exemplary embodiment of a lens assembly of the present invention are shown.

The present invention provides a lens assembly for use with a vehicle camera or imager, such as a high dynamic range (HDR) imager, such as the HDR Imager Aptima AR132 or the like. The HDR imager is highly sensitive to scattered light. Therefore, efforts have been made in the design of the present invention to reduce stray light at the imager. The lens assembly of the present invention may provide enhanced imaging and may reduce costs. The lens assembly provides a doublet lens (having two lens optics adhered or bonded together) at the rear position (generally at or near or towards the imaging array). Such a configuration provides advantages in the light ray route. Optionally, and desirably, only the front or first or outer optic comprises glass, and most or all of the rest of the optics may comprise a plastic or polymeric or acrylic material.

The lens assembly of the present invention is suitable for use with a wide angle camera, such as a camera having a wide angle field of view of up to about 180 degrees or about 190 degrees or the like, and preferably for use with a HDR (high dynamic range) camera or the like. The lens assembly includes the lens duplet or doublet (stack of glued lenses) lens design or configuration at the inner end of the lens stack. The doublet lens has two lens optics adhered or glued or bonded together.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, an array of a plurality of photosensor elements arranged in at least 640 columns and 480 rows (preferably a megapixel imaging array or the like), with a respective lens focusing images onto respective portions of the array. The photosensor array may comprise a plurality of photosensor elements arranged in a photosensor array having rows and columns. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 201 2/1 581 67; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661; and/or WO 2013/158592 and/or U.S. patent applications, Ser. No. 14/107,624, filed Dec. 16, 2013 (Attorney Docket MAG04 P-2206); Ser. No. 14/102,981, filed Dec. 11, 2013 (Attorney Docket MAG04 P-2196); Ser. No. 14/102,980, filed Dec. 11, 2013 (Attorney Docket MAG04 P-2195); Ser. No. 14/098,817, filed Dec. 6, 2013 (Attorney Docket MAGO4 P-2193); Ser. No. 14/097,581, filed Dec. 5, 2013 (Attorney Docket MAG04 P-2192); Ser. No. 14/093,981, filed Dec. 2, 2013 (Attorney Docket MAG04 P-2197); Ser. No. 14/093,980, filed Dec. 2, 2013 (Attorney Docket MAG04 P-2191); Ser. No. 14/082,573, filed Nov. 18, 2013 (Attorney Docket MAG04 P-2183); Ser. No. 14/082,574, filed Nov. 18, 2013 (Attorney Docket MAG04 P-2184); Ser. No. 14/082,575, filed Nov. 18, 2013 (Attorney Docket MAG04 P-2185); Ser. No. 14/082,577, filed Nov. 18, 2013 (Attorney Docket MAG04 P-2203); Ser. No. 14/071,086, filed Nov. 4, 2013 (Attorney Docket MAG04 P-2208); Ser. No. 14/076,524, filed Nov. 11, 2013 (Attorney Docket MAG04 P-2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P-2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 61/919,129, filed Dec. 20, 2013; Ser. No. 61/919,130, filed Dec. 20, 2013; Ser. No. 61/919,131, filed Dec. 20, 2013; Ser. No. 61/919,147, filed Dec. 20, 2013; Ser. No. 61/919,138, filed Dec. 20, 2013, Ser. No. 61/919,133, filed Dec. 20, 2013; Ser. No. 61/918,290, filed Dec. 19, 2013; Ser. No. 61/915,218, filed Dec. 12, 2013; Ser. No. 61/912,146, filed Dec. 5, 2013; Ser. No. 61/911, 666, filed Dec. 4, 2013; Ser. No. 61/911,665, filed Dec. 4, 2013; Ser. No. 61/905,461, filed Nov. 18, 2013; Ser. No. 61/905,462, filed Nov. 18, 2013; Ser. No. 61/901,127, filed Nov. 7, 2013; Ser. No. 61/895,610, filed Oct. 25, 2013; Ser. No. 61/895,609, filed Oct. 25, 2013; Ser. No. 61/893,489, filed Oct. 21, 2013; Ser. No. 61/886,883, filed Oct. 4, 2013; Ser. No. 61/879,837, filed Sep. 19, 2013; Ser. No. 61/879,835, filed Sep. 19, 2013; Ser. No. 61/878,877, filed Sep. 17, 2013; Ser. No. 61/875,351, filed Sep. 9, 2013; Ser. No. 61/869,195, filed. Aug. 23, 2013; Ser. No. 61/864,835, filed Aug. 12, 2013; Ser. No. 61/864,836, filed Aug. 12, 2013; Ser. No. 61/864,837, filed Aug. 12, 2013; Ser. No. 61/864,838, filed Aug. 12, 2013; Ser. No. 61/856,843, filed Jul. 22, 2013, Ser. No. 61/845,061, filed Jul. 11, 2013; Ser. No. 61/844,630, filed Jul. 10, 2013; Ser. No. 61/844,173, filed Jul. 9, 2013; Ser. No. 61/844,171, filed Jul. 9, 2013; Ser. No. 61/842,644, filed Jul. 3, 2013; Ser. No. 61/840,542, filed Jun. 28, 2013; Ser. No. 61/838,619, filed Jun. 24, 2013; Ser. No. 61/838,621, filed Jun. 24, 2013; Ser. No. 61/837,955, filed Jun. 21, 2013; Ser. No. 61/836,900, filed Jun. 19, 2013; Ser. No. 61/836,380, filed Jun. 18, 2013; Ser. No. 61/834,129, filed Jun. 12, 2013; Ser. No. 61/833,080, filed Jun. 10, 2013; Ser. No. 61/830,375, filed Jun. 3, 2013; Ser. No. 61/830,377, filed Jun. 3, 2013; Ser. No. 61/825,752, filed May 21, 2013; Ser. No. 61/825,753, filed May 21, 2013; Ser. No. 61/823,648, filed May 15, 2013; Ser. No. 61/823,644, filed May 15, 2013; Ser. No. 61/821,922, filed May 10, 2013; Ser. No. 61/819,835, filed May 6, 2013; Ser. No. 61/819,033, filed May 3, 2013; Ser. No. 61/816,956, filed Apr. 29, 2013; Ser. No. 61/815,044, filed Apr. 23, 2013; Ser. No. 61/814,533, filed Apr. 22, 2013; Ser. No. 61/813,361, filed Apr. 18, 2013; Ser. No. 61/810,407, filed Apr. 10, 2013; Ser. No. 61/808,930, filed Apr. 5, 2013; Ser. No. 61/807,050, filed Apr. 1, 2013; Ser. No. 61/806,674, filed Mar. 29, 2013; Ser. No. 61/793,592, filed Mar. 15, 2013; Ser. No. 61/772,015, filed Mar. 4, 2013; Ser. No. 61/772,014, filed Mar. 4, 2013; Ser. No. 61/770,051, filed Feb. 27, 2013; Ser. No. 61/766,883, filed Feb. 20, 2013; Ser. No. 61/760,366, filed Feb. 4, 2013; Ser. No. 61/760,364, filed Feb. 4, 2013; Ser. No. 61/756,832, filed Jan. 25, 2013; and/or Ser. No. 61/754,804, filed Jan. 21, 2013, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and 6,824,281, and/or International Publication Nos. WO 2010/099416; WO 2011/028686; and/or WO 2013/016409, and/or U.S. patent application Ser. No. 12/508,840, filed Jul. 24, 2009, and published Jan. 28, 2010 as U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. patent applications, Ser. No. 12/091,359, filed Apr. 24, 2008 and published Oct. 1, 2009 as U.S. Publication No. US-2009-0244361, and/or Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,720,580; 7,038,577; 5,929,786 and/or 5,786,772, and/or U.S. pat. applications, Ser. No. 11/239,980, filed Sep. 30, 2005, now U.S. Pat. No. 7,881,496, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. patent applications, Ser. No. 11/226,628, filed Sep. 14, 2005 and published Mar. 23, 2006 as U.S. Publication No. US-2006-0061008, and/or Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in PCT Application No. PCT/US2011/056295, filed Oct. 14, 2011 and published Apr. 19, 2012 as International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO2012/075250; WO 2013/019795; WO 2012/075250; WO 2012/145822; WO 2013/081985; WO 2013/086249; and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. patent applications, Ser. No. 12/091,525, filed Apr. 25, 2008, now U.S. Pat. No. 7,855,755; Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. patent application Ser. No. 10/538,724, filed Jun. 13, 2005 and published Mar. 9, 2006 as U.S. Publication No. US-2006-0050018, which are hereby incorporated herein by reference in their entireties.

While the above description constitutes a plurality of embodiments of the present invention, it will be appreciated that the present invention is susceptible to further modification and change without departing from the fair meaning of the accompanying claims.

1. A vehicular vision system, said vehicular vision system comprising:
a camera comprising an image sensing array and a lens assembly;
wherein said camera is disposed at a vehicle and has a field of view exterior of the vehicle, wherein said image sensing array is operable to capture image data;
wherein said lens assembly images light onto said image sensing array and wherein said lens assembly comprises a plurali Fürsichty of optic elements disposed along an optic path generally perpendicular to said image sensing array; and
wherein said plurality of optic elements comprises (i) an outer wide angle glass optic, (ii) a doublet optic comprising two optic elements that are bonded together and (iii) at least one intermediate plastic optic disposed between said doublet optic and said outer wide angle glass optic, and wherein said doublet optic is disposed closer to said image sensing array than said outer wide angle glass optic.

2. The vehicular vision system of claim 1, wherein said doublet optic comprises two plastic optic elements that are bonded together.

3. The vehicular vision system of claim 1, wherein said at least one intermediate plastic optic comprises a first intermediate plastic optic and a second intermediate plastic optic, and wherein said second intermediate plastic optic is disposed between said first intermediate plastic optic and said doublet optic.

4. The vehicular vision system of claim 3, wherein said at least one intermediate plastic optic comprises a third intermediate plastic optic disposed between said second intermediate plastic optic and said doublet optic.

5. The vehicular vision system of claim 4, wherein said third intermediate plastic optic is bonded to one of said optic elements of said doublet optic.

6. A vehicular vision system, said vehicular vision system comprising:
a camera comprising an image sensing array and a lens assembly;
wherein said camera is disposed at a vehicle and has a field of view exterior of the vehicle, wherein said image sensing array is operable to capture image data;
wherein said lens assembly images light onto said image sensing array and wherein said lens assembly comprises:
a first lens element comprising an outer lens element and having a convex outer surface facing the exterior of the vehicle and a concave inner surface facing said image sensing array;
a second lens element having an aspheric surface facing said first lens element and a concave surface facing said image sensing array;
a third lens element having a positive breaking power;
a stop;
a fourth lens element having a positive breaking power; and
a doublet optic comprising fifth and sixth lens elements bonded together, wherein said doublet optic has a positive breaking power, and wherein said doublet optic is disposed closer to said image sensing array than said second, third and fourth lens elements, and wherein said second, third and fourth lens elements are disposed between said first lens element and said doublet optic.

7. The vehicular vision system of claim 6, wherein said fifth and sixth lens elements comprise plastic lens elements.

8. The vehicular vision system of claim 6, wherein said doublet optic comprises at least one aspheric surface.

9. The vehicular vision system of claim 6, wherein said fourth lens element comprises at least one aspheric surface.

10. The vehicular vision system of claim 6, wherein said lens elements comprise the following properties:
said first lens element has a refraction index>1.65 and Abbe coefficient>50;
said second lens element has a refraction index>1.45 and Abbe coefficient>50;
said third lens element has a refraction index>1.65 and Abbe coefficient<30;
said fourth lens element has a refraction index>1.5 and Abbe coefficient>50;
said fifth lens element has a refraction index>1.5 and Abbe coefficient<30; and
said sixth lens element has a refraction index>1.5 and Abbe coefficient>50.

11. The vehicular vision system of claim 6, wherein a seventh lens element is bonded to said sixth lens element to form a triplet optic having a positive breaking power.

12. A vehicular vision system, said vehicular vision system comprising:
a camera comprising an image sensing array and a lens assembly;
wherein said camera is disposed at a vehicle and has a field of view exterior of the vehicle, wherein said image sensing array is operable to capture image data;
wherein said lens assembly images light onto said image sensing array and wherein said lens assembly comprises:
a first lens element comprising an outer lens element and having a convex outer surface facing the exterior of the vehicle and a concave inner surface facing said image sensing array;
a second lens element having an aspheric surface facing said first lens element and a concave surface facing said image sensing array;
a third lens element having a positive breaking power;
a stop; and
fourth and fifth lens elements provided as a bonded doublet optic having a positive breaking power, wherein said doublet optic is disposed closer to said image sensing array than said second and third lens elements, and wherein said second and third lens elements are disposed between said first lens element and said doublet optic.

13. The vehicular vision system of claim 12, wherein said fourth lens element has a fourth Abbe coefficient and said fifth lens element has a fifth Abbe coefficient, said fourth Abbe coefficient being higher than said fifth Abbe coefficient, and wherein said fourth lens element has a positive breaking power and said fifth lens element has a negative breaking power.

14. The vehicular vision system of claim 12, wherein said fourth lens element has a fourth Abbe coefficient and said fifth lens element has a fifth Abbe coefficient, said fourth Abbe coefficient being lower than said fifth Abbe coefficient, and wherein said fourth lens element has a negative breaking power and said fifth lens element has a positive breaking power.

15. The vehicular vision system of claim 12, wherein said fourth and fifth lens elements comprise at least one aspheric surface.

16. The vehicular vision system of claim 12, wherein said fourth and fifth lens elements comprise plastic lens elements.

17. The vehicular vision system of claim 12, wherein said lens assembly comprises a filter disposed between said doublet optic and said image sensing array, wherein said filter comprises an infrared absorbing substrate comprising an antireflective coating on one side and an infrared absorbing coating on another side.

18. The vehicular vision system of claim 12, wherein said fourth and fifth lens elements of said doublet optic are bonded together by using one of (i) an epoxy resin, (ii) an acrylate resin and (iii) a modified acrylate resin.

19. The vehicular vision system of claim 12, wherein said lens assembly comprises a barrel comprising a barrel material and a lens holder comprising a lens holder material, and wherein said barrel material has a lower thermal coefficient of expansion than said lens holder material.

20. The vehicular vision system of claim 19, wherein at least one of (i) said barrel is formed by injection molding, (ii) said barrel is formed by injection molding using one or more injection gates at a rear portion of said barrel, (iii) said barrel is formed using a round injection gate at a rear portion of said barrel and (iv) said lens holder is formed by injection molding using one or more injection points at a side portion of said lens holder.
